(19) United States
(12) Patent Application Publication
(10) Pub. No.: US 2022/0030872 A1
(43) Pub. Date: Feb. 3, 2022

(54) CHLORINE DIOXIDE SUSTAINED-RELEASING DISINFECTING NANO MATERIAL AND PREPARATION METHOD AND USE THEREOF

(71) Applicant: Sun Yat-sen University, Guangzhou City (CN)

(72) Inventors: Jiahai LU, Guangzhou City (CN); Panpan XUE, Guangzhou City (CN); Zhongmin GUO, Guangzhou City (CN); Conghui LIAO, Guangzhou City (CN)

(73) Assignee: Sun Yat-sen University, Guangzhou City (CN)

(21) Appl. No.: 17/392,507

(22) Filed: Aug. 3, 2021

(30) Foreign Application Priority Data
Aug. 3, 2020 (CN) 202010766677

(51) Int. Cl. A01N 59/00; A01N 25/12; A01N 25/08; A01P 1/00

(52) U.S. Cl. CPC A01N 59/00; A01P 1/00; A01N 25/08; A01N 25/12

(57) ABSTRACT

A chlorine dioxide sustained-releasing sterilizing and disinfecting nano material, and a preparation method and use thereof are disclosed. A support, i.e., a porous material with silicon dioxide as a main component, is soaked in a chlorine dioxide-containing solution to adsorb chlorine dioxide on the surface of silicon dioxide, and the resulting mixture is filtered, and the obtained solid is dried to obtain the chlorine dioxide sustained-releasing sterilizing and disinfecting nano material. When the chlorine dioxide sustained-releasing sterilizing and disinfecting nano material is used for sterilizing and disinfecting, the adsorbed chlorine dioxide reacts with water physically and chemically adsorbed on the surface of the support to generate a large quantity of active groups .OH, and meanwhile sustainedly release dioxide chlorine gas, having a synergistic effect, and thereby enabling the material finally to exhibit high-efficiency and excellent sterilizing and disinfecting performance.

### CROSS REFERENCE TO RELATED APPLICATION

This application claims the priority of Chinese Patent Application No. 202010766677.1, entitled “Chlorine dioxide sustained-releasing disinfecting nano material and preparation method and use thereof” filed with the Chinese National Intellectual Property Administration on Aug. 3, 2020, which is incorporated herein by reference in its entirety.

### TECHNICAL FIELD

The disclosure relates to the field of disinfection materials, in particular to a chlorine dioxide sustained-releasing disinfecting nano material, and a preparation method and use thereof.

### BACKGROUND

Chlorine dioxide is recognized as a broad-spectrum and highly effective fourth-generation green disinfectant. It has been widely used for disinfection, sterilization and deodorization in the field such as food industry, medical and pharmaceutical industries, animal and aquaculture husbandry, drinking water, and public environments. Although the excellent performance of chlorine dioxide itself has been widely recognized, its use in environments where human exist is still at a relatively early stage, and relevant research results at home and abroad are rare.

Traditional methods for preparing chlorine dioxide gas are mainly liquid-liquid methods in which chlorate (or chlorite) reacts with acid or gas-solid methods in which chlorine is displaced. However, the above two methods have the following technical problems: (1) it is easy to produce harmful gases such as chlorine, which is not good for human health, and is easy to cause secondary pollution; (2) the process of chemical reaction is difficult to control, that is to say, the concentration of the prepared chlorine dioxide gas is difficult to control, and it is easy to produce high-concentration chlorine dioxide gas instantaneously. In addition, the chlorine dioxide liquid preparation itself is easily affected by the external environment, and it is easy to decompose and volatilize, making it difficult to transport and store. Therefore, there is a need for a disinfectant material that is easy to transport, store, and could provide a sustained release of chlorine dioxide, and a controllable concentration of chlorine dioxide.

### SUMMARY

An object of the present disclosure is to provide a method for preparing a chlorine dioxide sustained-releasing sterilizing and disinfecting nano material. The chlorine dioxide sustained-releasing sterilizing and disinfecting nano material prepared by the method according to the present disclosure is easy to transport and store, and could provide a sustained release of chlorine dioxide, with a controllable concentration of chlorine dioxide.

In order to achieve the above-mentioned object of the disclosure, the present disclosure provides the following technical solutions:

The present disclosure provides a method for preparing a chlorine dioxide sustained-releasing sterilizing and disinfecting nano material, comprising soaking a support in a chlorine dioxide-containing solution, and filtering the resulting mixture, to obtain a solid, and drying the solid, to obtain the chlorine dioxide sustained-releasing sterilizing and disinfecting nano material, wherein the support is a porous material with nano-silicon dioxide as a main component.

In some embodiments, the support is prepared by a method comprising mixing a nano-silicon dioxide sol with a particle size of 1-100 nm, absolute ethanol, and deionized water, with a volume ratio of (0.75-1.5):(1-3):(6-8), to obtain a mixed solution, and adjusting a pH value of the mixed solution to 7.4-7.6, and drying, to obtain the support.

In some embodiments, the support has a particle size of 2 to 4 mm.

In some embodiments, the chlorine dioxide-containing solution has a chlorine dioxide concentration of 5-20 wt %.

In some embodiments, a mass ratio of the chlorine dioxide-containing solution to the support is in the range of (21-26):10.

In some embodiments, soaking a support in a chlorine dioxide-containing solution is performed at a temperature of 24-26° C. for 18-26 hours.

In some embodiments, drying the solid is performed by a natural air drying.

The present disclosure also provides a chlorine dioxide sustained-releasing sterilizing and disinfecting nano material prepared by the method as described in the above technical solution.

The present disclosure also provides use of the chlorine dioxide sustained-releasing sterilizing and disinfecting nano material as described in the above technical solution in the field of sterilizing and disinfecting.

The present disclosure provides a method for preparing a sterilizing and disinfecting chlorine dioxide sustained release nanomaterial. In the method, a support, i.e., a porous material with silicon dioxide as a main component, is soaked in a chlorine dioxide-containing solution to adsorb chlorine dioxide on the surface of silicon dioxide, and the resulting mixture is filtered and the obtained solid is dried to obtain the chlorine dioxide sustained-releasing sterilizing and disinfecting nano material. When used for sterilizing and disinfecting, the adsorbed chlorine dioxide in the chlorine dioxide sustained-releasing sterilizing and disinfecting nano material causes the water physically adsorbed on the surface of silicon dioxide in the support (i.e., crystal water) to undergo ionized hydrolysis, as presented by H₂O→H⁺+OH⁻, so that the slow hydrolysis of chlorine dioxide occurs, as presented by ClO₂+H₂O→HClO₂+HClO₃, and meanwhile, causes the water chemically adsorbed on the surface of the silicon dioxide in the support (i.e., water molecules that could be bonded with silicon dioxide to form hydroxyl groups) to undergo the following non-ionic hydrolysis: (1)

H₂O [symbol] ⋅H+OH; (2) ClO₂+.H→HClO₂ (the overall reaction of Formula (1) and Formula (2) is ClO₂+H₂O→HClO₂+.OH); (3) 2.OH→H₂O₂; (4) .OH+H₂O₂→.HO₂+H₂O. Therefore, a large quantity of active groups .OH are finally generated, and in this process, the chlorine dioxide sustained-releasing sterilizing and disinfecting nano material meanwhile sustainably releases chlorine dioxide gas, and synergistic effect of a large quantity of active groups .OH (oxidation potential reaching 2.80 ev) generated on the surface and sustained release of chlorine dioxide enables the material to finally exhibit high-efficiency and excellent sterilizing and disinfecting performance, and the chlorine dioxide sustained-releasing sterilizing and disinfecting nano material prepared by the method according to the present disclosure is easy to transport and store, and the concentration of released chlorine dioxide gas is in the range of 0.01-0.15 ppm, and the release is sustained for 3-6 months, having an effect of long-term sustained release of chlorine dioxide. Moreover, the concentration of released chlorine dioxide is low and controllable, which enables the material to be used in the environment where human exists. The results of the examples show that the chlorine dioxide sustained-releasing sterilizing and disinfecting nano material prepared by the method according to the present disclosure could kill 99.6% of influenza A virus H1N1 within 2 hours, and could kill 99.9% of Staphylococcus albicans within 2 hours, and could kill 99.4% of the natural bacteria in air within 24 hours, exhibiting excellent sterilizing and disinfecting performance. The release of chlorine dioxide at a concentration higher than 0.01 ppm is sustained for as long as 3-6 months. Thus, the material has the effect of long-term sustained release of chlorine dioxide, and the concentration of released chlorine dioxide is low. Therefore, the chlorine dioxide sustained-releasing sterilizing and disinfecting nano material could be used in the environment that needs to be sterilized and disinfected for a long time where human exists.

The method for preparing a chlorine dioxide sustained-releasing sterilizing and disinfecting nano material according to the present disclosure is simple in operation, could be implemented under mild reaction conditions, and is suitable for large-scale production.

### DETAILED DESCRIPTION OF ILLUSTRATIVE EMBODIMENTS

The present disclosure provides a method for preparing a chlorine dioxide sustained-releasing sterilizing and disinfecting nano material, comprising soaking a support in a chlorine dioxide containing solution, and filtering the resulting mixture, to obtain a solid, and drying the solid, to obtain the chlorine dioxide sustained-releasing sterilizing and disinfecting nano material, wherein the support is a porous material with nano-silicon dioxide as a main component.

In the present disclosure, the support is soaked in a chlorine dioxide-containing solution, and the resulting mixture is filtered, to obtain a solid, and the solid is dried, to obtain the chlorine dioxide sustained-releasing sterilizing and disinfecting nano material.

In some embodiments of the present disclosure, the support is prepared by a method comprising mixing a nano-silicon dioxide sol with a particle size of 1-100 nm, absolute ethanol, and deionized water, with a volume ratio of (0.75-1.5):(1-3):(6-8), to obtain a mixed solution; and adjusting a pH value of the mixed solution to 7.4-7.6, and drying the adjusted mixed solution, to obtain the support. In the present disclosure, since nano-silicon dioxide is easy to agglomerate, it is difficult to operate when used directly as a support. The present disclosure adopts the method to prepare nano-silicon dioxide as a support, which could ensure that the support has the characteristics of a larger specific surface area and a specific particle size, thereby being conducive to experimental operations.

In some embodiments of the present disclosure, the support has a particle size of 2 to 4 mm, and more preferably 2 to 3 mm. In the present disclosure, since nano-silicon dioxide has a small particle size and is easy to agglomerate. In the present disclosure, nano-silicon dioxide is prepared to a support, which could ensure a particle size of preferably 2 to 4 mm, thereby being more conducive to experimental operations.

In the present disclosure, there are no particular limitations to the operation for mixing a nano-silicon dioxide sol, absolute ethanol, and deionized water, and the operation for mixing well known to those skilled in the art may be used. In some embodiments of the present disclosure, the mixing includes a mechanical stirring.

In some embodiments of the present disclosure, the nano-silicon dioxide sol has a particle size of 10 to 90 nm, and more preferably 20 to 80 nm. In the present disclosure, there are no particular limitations to the source of the nano-silicon dioxide sol, and commercially available products well known to those skilled in the art may be used, as long as the above-mentioned particle size could be achieved. In the present disclosure, the silicon dioxide sol having a particle size within the above range is beneficial to increase the surface area of the support and adsorb more chlorine dioxide, thereby improving the long-term sterilizing and disinfecting performance of the prepared chlorine dioxide sustained-releasing sterilizing and disinfecting nano material. In the present disclosure, there are no particular limitations to the source of the support, and commercially available products well known to those skilled in the art may be used.

In some embodiments of the present disclosure, the volume ratio of the nano-silicon dioxide sol, absolute ethanol, and deionized water is in the range of (0.8-1):(2-3):(7-8), and more preferably 1:2:7. In the present disclosure, the ratio of the nano-silicon dioxide sol, absolute ethanol, and deionized water within the above range is more conducive to obtaining a support with a good chlorine dioxide sustained release effect.

In some embodiments of the present disclosure, the pH value is in the range of 7.4-7.6, and more preferably 7.5. In the present disclosure, the pH value within the above range is more conducive to obtaining a support with a good chlorine dioxide sustained release effect. In some embodiments of the present disclosure, the pH value is adjusted by using solvent, i.e. concentrated aqueous ammonia.

In some embodiments of the present disclosure, the method further comprises stirring the mixed solution after adjusting the pH value, wherein the stirring is preformed for 5-20 min. In the present disclosure, there are no particular limitations to the stirring rate, as long as the components could be fully mixed.

In some embodiments of the present disclosure, drying the adjusted mixed solution is preformed at a temperature of 90° C. to 120° C., and more preferably 100° C. to 110° C. In some embodiments, drying the adjusted mixed solution is preformed for 1 to 6 hours, and more preferably 2 to 4 hours. In some embodiments of the present disclosure, the temperature and time for drying the adjusted mixed solution are defined in the above range, which achieves that the support could be dried without destroying the surface properties of the support.

In some embodiments of the present disclosure, the chlorine dioxide-containing solution has a chlorine dioxide concentration of 5-20 wt %, and more preferably 6-15 wt %. In the present disclosure, the chlorine dioxide concentration of the chlorine dioxide-containing solution is controlled within the above-mentioned range to avoid too high concentration, which would cause too high chlorine dioxide concentration released by the finally prepared chlorine dioxide sustained-releasing sterilizing and disinfecting nano material, thereby being not good for human health, and meanwhile to avoid too low concentration, which would cause too low chlorine dioxide concentration released by the finally prepared chlorine dioxide sustained-releasing sterilizing and disinfecting nano material, thereby not having an effective sterilizing and disinfecting effect.

In the present disclosure, there are no particular limitations to the preparation method of the chlorine dioxide-containing solution, and a preparation method well known to those skilled in the art may be used. In some embodiments of the present disclosure, the method for preparing the chlorine dioxide-containing solution is implemented as follows: mixing sodium chlorite, sodium chloride, sodium bicarbonate and sodium bisulfate to obtain a solid mixture; and then dissolving the solid mixture in deionized water, to obtain the chlorine dioxide-containing solution; or dissolving a common commercially available chlorine dioxide effervescent tablet in deionized water, to obtain the chlorine dioxide-containing solution.

In the present disclosure, there are no particular limitations to means for mixing sodium chlorite, sodium chloride, sodium bicarbonate and sodium bisulfate, as long as they could be mixed to be uniform. In some embodiments of the present disclosure, a mass ratio of sodium chlorite, sodium chloride, sodium bicarbonate and sodium bisulfate is in the range of (1-3):(1-3):(0.75-1.5):(0.75-1.5), and more preferably 1:1:0.5:0.5. In some embodiments of the present disclosure, a mass ratio of the solid mixture and deionized water is in the range of (1-6):20, and more preferably (3-4):20.

In some embodiments of the present disclosure, a mass ratio of the common commercially available chlorine dioxide effervescent tablet and deionized water is in the range of (0.15-5):1, and more preferably (0.2-4):1. In the present disclosure, when the mass ratio of the chlorine dioxide effervescent tablet and deionized water is within the above range, a chlorine dioxide-containing solution with a chlorine dioxide concentration of 5-20 wt % could be obtained.

In some embodiments of the present disclosure, a mass ratio of the chlorine dioxide-containing solution to the support is in the range of (21-26):10, and more preferably (23-24):10. In the present disclosure, the mass ratio of the chlorine dioxide-containing solution and the support is controlled within the above range, to avoid too high chlorine dioxide concentration released by the final prepared chlorine dioxide sustained-releasing sterilizing and disinfecting nano material, which is not good for human health, and meanwhile to avoid too low chlorine dioxide concentration released by the final prepared chlorine dioxide sustained-releasing sterilizing and disinfecting nano material, which could not achieve effective sterilizing and disinfecting effects.

In some embodiments of the present disclosure, soaking a support in a chlorine dioxide-containing solution is performed at a temperature of 24 to 26° C., and more preferably 23 to 25° C. In some embodiments, soaking a support in a chlorine dioxide-containing solution is performed for 18 to 26 hours, and more preferably 20 to 24 hours. In the present disclosure, the temperature and time for soaking a support in a chlorine dioxide-containing solution defined within the above ranges is conducive to promoting chlorine dioxide in the chlorine dioxide-containing solution to be fully adsorbed to the surface of the support, thereby improving sterilizing and disinfecting effects of the prepared chlorine dioxide sustained-releasing sterilizing and disinfecting nano material.

In the present disclosure, there are no particular limitations to the means for filtering, as long as the solid-liquid separation could be realized.

In some embodiments of the present disclosure, drying the solid is performed by a natural air drying. In the present disclosure, the soaked support is naturally dried to obtain a dry chlorine dioxide sustained-releasing sterilizing and disinfecting nano material, which avoids that water physically adsorbed on the surface of the support, i.e. crystal water, is lost. In the present disclosure, there are no particular limitations to the time for drying the solid, and it is feasible that the solid is dried until becoming white, to obtain the chlorine dioxide sustained-releasing sterilizing and disinfecting nano material.

The method for preparing the chlorine dioxide sustained-releasing sterilizing and disinfecting nano material according to the present disclosure is simple in operation, could be implemented under mild reaction conditions, and is suitable for large-scale production.

The present disclosure also provides a chlorine dioxide sustained-releasing sterilizing and disinfecting nano material prepared by the method described in the above technical solutions. In some embodiments of the present disclosure, the chlorine dioxide sustained-releasing sterilizing and disinfecting nano material comprises a support, and chlorine dioxide and a large quantity of active groups .OH supported on the surface of the support.

The present disclosure also provides use of the chlorine dioxide sustained-releasing sterilizing and disinfecting nano material in the field of sterilizing and disinfecting. In the present disclosure, the chlorine dioxide sustained-releasing sterilizing and disinfecting nano material could kill bacteria and viruses, and thus could be used as a sterilizing and disinfecting reagent in the environment where human exists. In some embodiments, the bacteria and viruses include one or more of staphylococcus albicans; natural bacteria in air; influenza A virus; Staphylococcus aureus; Aspergillus niger; mycolicibacterium smegmatis; bacteriophage; classical swine fever virus; porcine blue-ear virus; hand, foot and mouth virus; hepatitis virus; human immunodeficiency virus (HIV); spores; mycoplasma; and chlamydia.

When the material prepared by the method according to the present disclosure is used to sterilize and disinfect, the adsorbed chlorine dioxide reacts with water physically and chemically adsorbed on the surface of the support to generate a large quantity of active groups .OH, and meanwhile sustainedly release dioxide chlorine gas, having a synergistic effect, and thereby enabling the material finally to exhibit high-efficiency and excellent sterilizing and disinfecting performance. Moreover, the prepared chlorine dioxide sustained-releasing sterilizing and disinfecting nano material is easy to transport and store, and releases chlorine dioxide gas at a concentration of 0.01-0.15 ppm for 3-6 months. Thus, the material has the effect of long-term sustained release of chlorine dioxide, and the concentration of released chlorine dioxide is low and controllable. Therefore, the material could be used in the environment where human exists.

The technical solutions of the present disclosure will be clearly and completely described below in conjunction with the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative labor shall fall within the scope of the present disclosure.

### Example 1

1. Preparation of a Chlorine Dioxide Containing Solution

150 g of chlorine dioxide effervescent tablets were dissolved in 1000 g of deionized water, obtaining the chlorine dioxide containing solution, the chlorine dioxide concentration of which was 10 wt %.

2. Preparation of a Chlorine Dioxide Sustained-Releasing Sterilizing and Disinfecting Nano Material

500 g of porous silicon dioxide particles with a particle size of 2-4 mm were added to the chlorine dioxide containing solution as prepared by above-mentioned method, and soaked at 24° C. for 24 hours. The resulting mixture was filtered, obtaining a solid. The solid was dried naturally, obtaining 750 g of the chlorine dioxide sustained-releasing sterilizing and disinfecting nano material.

3. Detection of the Released Chlorine Dioxide Gas by the New Chlorine Dioxide Sustained-Releasing Sterilizing and Disinfecting Nano Material as Prepared Above

5 groups of new chlorine dioxide sustained-releasing sterilizing and disinfecting nano materials as prepared above were taken and put into volumetric flasks respectively, with a weight of 30 g, 50 g, 100 g, 250 g and 500 g respectively, two volumetric flasks for each group, and then the volumetric flasks were placed in a room that was normally ventilated. The time for releasing chlorine dioxide and the concentration of the released chlorine dioxide for each group were tested by using the portable pump-suction chlorine dioxide gas detector PLT300 (from PuLiTong Electronic Technology Co., Ltd., ShenZhen, China), and the concentration of chlorine dioxide in air of ach group of volumetric flasks was tested every week, three times for each volumetric flask, the average value of which was taken as the actual measurement result, until the chlorine dioxide gas in air of the volumetric flask could not be detected. The specific experimental results are shown in Table 1.

TABLE 1
Concentrations of the released chlorine dioxide of the chlorine dioxide sustained-
releasing sterilizing and disinfecting nano material with different weights over time

| | Group 1 (500 g) | Group 2 (250 g) | Group 3 (100 g) | Group 4 (50 g) | Group 5 (30 g) |
|---|---|---|---|---|---|
| | Concentration | Concentration | Concentration | Concentration | Concentration |
| | of released | of released | of released | of released | of released |
| | chlorine | chlorine | chlorine | chlorine | chlorine |
| Days | dioxide (ppm) | dioxide (ppm) | dioxide (ppm) | dioxide (ppm) | dioxide (ppm) |
| Day 1 | 0.15 | 0.14 | 0.13 | 0.125 | 0.11 |
| Day 8 | 0.135 | 0.125 | 0.11 | 0.105 | 0.1 |
| Day 15 | 0.12 | 0.115 | 0.10 | 0.09 | 0.08 |
| Day 22 | 0.105 | 0.10 | 0.08 | 0.075 | 0.065 |
| Day 29 | 0.09 | 0.08 | 0.07 | 0.06 | 0.05 |
| Day 36 | 0.08 | 0.075 | 0.065 | 0.05 | 0.04 |
| Day 43 | 0.085 | 0.065 | 0.06 | 0.05 | 0.035 |
| Day 50 | 0.07 | 0.060 | 0.055 | 0.045 | 0.035 |
| Day 57 | 0.065 | 0.055 | 0.055 | 0.045 | 0.03 |
| Day 64 | 0.07 | 0.060 | 0.045 | 0.05 | 0.025 |
| Day 71 | 0.065 | 0.055 | 0.045 | 0.05 | 0.02 |
| Day 78 | 0.60 | 0.05 | 0.045 | 0.05 | 0.02 |
| Day 85 | 0.55 | 0.05 | 0.045 | 0.045 | 0.015 |
| Day 92 | 0.05 | 0.045 | 0.04 | 0.04 | 0.015 |
| Day 99 | 0.04 | 0.045 | 0.03 | 0.035 | 0.015 |
| Day 106 | 0.04 | 0.04 | 0.025 | 0.025 | 0.01 |
| Day 113 | 0.45 | 0.035 | 0.025 | 0.025 | 0.01 |
| Day 120 | 0.04 | 0.025 | 0.03 | 0.02 | 0.02 |
| Day 127 | 0.03 | 0.025 | 0.02 | 0.02 | 0.01 |
| Day 134 | 0.03 | 0.03 | 0.02 | 0.015 | 0.005 |
| Day 141 | 0.025 | 0.025 | 0.02 | 0.015 | 0.005 |
| Day 148 | 0.025 | 0.02 | 0.01 | 0.01 | 0 |
| Day 155 | 0.015 | 0.015 | 0.01 | 0.01 | 0 |
| Day 162 | 0.015 | 0.01 | 0 | 0 | 0 |
| Day 169 | 0.01 | 0.01 | 0 | 0 | 0 |
| Day 176 | 0.01 | 0 | 0 | 0 | 0 |
| Day 183 | 0 | 0 | 0 | 0 | 0 |

### Use Example 1

The chlorine dioxide sustained-releasing sterilizing and disinfecting nano material as prepared in Example 1 was used to kill Staphylococcus albicans.

1. Materials and Equipment

(1) Staphylococcus albicans 8032 bacteria suspension (prepared according to “Technical Standard For Disinfection” 2002 edition 2.1.1.2);

(2) sampling liquid;

(3) neutralizer (identified qualified according to “Technical Standard For Disinfection” 2002 edition 2.1.1.5);

(4) phosphate buffered saline (PBS, 0.03 mol/L, pH being 7.2);

(5) ordinary nutrient broth medium;

(6) ordinary nutrient agar medium (when used for sterilization and disinfection test, the corresponding neutralizer was added therein);

(7) two test cabinets with the same internal environment (including temperature, humidity, light, airtightness, and ventilation conditions, etc.) (with a capacity of 1 m³, in accordance with “Technical Standard For Disinfection” 2002 Edition 2.1.3), one being considered as the experimental group, and the other being considered as the control group;

(8) spray bacteria contaminating device, comprising an air compressor, a pressure gauge, a gas flow meter and an aerosol sprayer;

(9) air microorganism sampling device, liquid impact microorganism aerosol sampler; and

(10) environmental condition monitoring equipment, comprising a thermometer and a hygrometer.

2. Procedure

(1) The above-mentioned staphylococcus albicans suspension was taken and filtered with sterile absorbent cotton, and diluted with nutrient broth medium to the required concentration.

(2) The test cabinets of the experimental group and the control group were adjusted to a temperature of 20° C.-25° C., and a humidity of 50%-70%.

(3) Equipment to be used was put into the test cabinet at one time, and the door was closed. After that, all operations and manipulations of the equipment were performed outside the test cabinet through a window with a sealed sleeve or a remote controller until the test was completed.

(4) The bacteria were sprayed according to the set pressure, gas flow and spray time, while stirring with a fan. After spraying the bacteria, the stirring was continued for another 5 minutes, and the resulting mixture was left standing for 5 minutes. Meanwhile the test cabinets of the experimental group and the control group were sampled by using liquid impact microorganism aerosol sampler at a flow rate of 11 L/min before disinfection (20 mL of the sampling liquid, and 2 min of the sampling time), as a positive control before the control group test and the disinfection treatment of the test group (i.e. the number of contaminated bacteria).

(5) 125 g of the chlorine dioxide sustained-releasing sterilizing and disinfecting nano material prepared in Example 1 was tiled in the test cabinet of the experimental group to disinfect.

(6) At 2 hours, the test cabinets of the experimental group and the control group were sampled simultaneously according to the method as described in step (4).

(7) In the laboratory experimental stage, the samples collected with the liquid impact sampler were cultured by viable count method in accordance with “Technical Standard For Disinfection” (2002 Edition 2.1.1.3), in which they were cultured in a incubator at 37° C. for 48 hours, and the number of bacterial in air of the test cabinet at the respective sampling time was calculated.

(8) After the whole test was completed, the final disinfection against the residual bacteria on the surface of the test cabinet and in air was performed. After that, the ventilator was turn on, to filter the sterilization exhaust air, and remove the contaminated air trapped in the cabinet (or room) for the next test.

(9) After sampling and sample-inoculating of the test group and the positive control group, the same batch of unused culture medium, sampling liquid, and PBS, etc. were sampled (each 1-2 groups) and cultured or cultured after inoculation at the same time as the above two sets of samples, as a negative control. If there is bacterial growth in the negative control group, it means that the medium or reagents used are contaminated and that the experiment is invalid. Therefore, the test should start again after replacing sterile materials and equipment.

(10) The valid experiment under the same conditions was repeated 3 times, and the killing rate was calculated separately for each time.

The killing rate was calculated according to the following formula:

$${N}_{t} = \frac{{V}_{0} - {V}_{t}}{{V}_{0}} \times 100 \%$$

$${K}_{t} = \frac{{V}_{0}^{′} ( 1 - {N}_{t} ) - {V}_{t}^{′}}{{V}_{0}^{′} ( 1 - {N}_{t} )} \times 100 \%$$

where Nₜ represents the natural killing rate of bacteria in air;
V₀ and Vₜ respectively represents the number of bacteria in air before the experiment and at different time point during the experiment of the control group;
Kₜ represents a killing rate of bacteria in air by disinfection treatment;
V₀′ and Vₜ′ respectively represents the number of bacteria in air before disinfection and at different time point during the disinfection of the experimental group, wherein
the number of bacteria in air before and after disinfection were calculated according to the following formula:

$$the number of bacteria ( cfu / {m}^{3} ) = \frac{{P}_{b} ( cfu )}{11 L / min \times sampling time ( min )} \times 1000$$

where P_{b} represents the total number of bacteria in the sampling plate.

The specific results were shown in Table 2.

TABLE 2
Experimental results of killing staphylococcus albicans (after
the effect of microbial natural killing in air has been eliminated)

| | Total number of | Total number of | |
|---|---|---|---|
| | bacteria in | bacteria in | |
| Experimental | air at 0 h | air at 2 h | Killing rate |
| times | (cfu/m³) | (cfu/m³) | Kₜ (%) |
| 1 | 3.8 × 10⁶ | <9.1 × 10² | >99.96 |
| 2 | 4.0 × 10⁶ | <9.1 × 10² | >99.96 |
| 3 | 3.7 × 10⁶ | <9.1 × 10² | >99.96 |

### Use Example 2

The chlorine dioxide sustained-releasing sterilizing and disinfecting nano material as prepared in Example 1 was used to kill natural bacteria in air.

1. Materials and Equipment

(1) test cabinet (with a capacity of 1 m³, in accordance with “Technical Standard For Disinfection” 2002 Edition 2.1.3);

(2) air microorganism sampling device, six-stage sieve air impingement type sampler (at a sampling flow of 28.3 L/min);

(3) neutralizer (identified qualified according to “Technical Standard For Disinfection” 2002 edition 2.1.1.5);

(4) phosphate buffered saline (PBS, 0.03 mol/L, pH being 7.2);

(5) ordinary nutrient broth medium; and

(6) ordinary nutrient agar medium.

2. Procedure

(1) The test cabinet under the natural condition was sampled (natural bacteria) by using a six-stage sieve air impingement type sampler at a sampling flow of 28.3 L/min for 5 minutes, as a sample before disinfection (a positive control).

(2) 125 g of material sample was tiled in the test cabinet and left stand for 24 hours, then the air in the test cabinet was sampled according to the method as described in step (1), as a sample after disinfection. The sample after disinfection was cultured by viable count method in accordance with “Technical Standard For Disinfection” (2002 Edition 2.1.1.3), in which it was cultured in a incubator at 37° C. for 48 hours, and the number of bacteria in air of the test cabinet at the respective sampling time was calculated.

(3) Due to the many changes in the environmental conditions of the field test, it was difficult to be consistent, and thus it was impossible to determine the accurate natural sedimentation rate, so the verification conclusion was made only according to the obtained killing rate (comprehensive sterilization effect of natural decay and disinfection treatment). The killing rate was calculated according to the following formula:

$$killing rate = \frac{{M}_{0} - {M}_{1}}{{M}_{0}} \times 100 \%$$

where M₀ represents average number of bacteria in the sample before disinfection, and
M₁ represents average number of bacteria in the sample after disinfection.

(4) After sampling, the same batch of unused culture medium was sampled and cultured or cultured after inoculation at the same time as the above sample, as a negative control. If there is bacterial growth in the negative control group, it means that the culture medium used is contaminated and that the experiment is invalid. Therefore, the experiment should start again after replacement until that the valid experiment is repeated 3 times. The killing rate for each time was calculated. The specific experimental results were shown in Table 3.

TABLE 3
Experimental results of killing natural bacteria in air

| | Total number of | Total number of | |
|---|---|---|---|
| | bacteria in | bacteria in | |
| Experimental | air at 0 h | air at 2 h | Killing rate |
| times | (cfu/m³) | (cfu/m³) | Kₜ(%) |
| 1 | 1.2 × 10³ | <7 | >99.42 |
| 2 | 1.2 × 10³ | <7 | >99.42 |
| 3 | 1.1 × 10³ | <7 | >99.36 |

### Use Example 3

The chlorine dioxide sustained-releasing sterilizing and disinfecting nano material as prepared in Example 1 was used to kill influenza virus H1N1.

1. Materials and Equipment

(1) experiment virus being influenza virus H1N1 (A/PR/8/34), the host cell being MDCK cell;

(2) sampling liquid;

(3) neutralizer (identified qualified according to “Technical Standard For Disinfection” 2002 edition 2.1.1.5);

(4) phosphate buffered saline (PBS, 0.03 mol/L, pH being 7.2);

(5) ordinary nutrient broth medium;

(6) ordinary nutrient agar medium;

(7) two test cabinets with the same internal environment (including temperature, humidity, light, airtightness, and ventilation conditions, etc.) (with a capacity of 1 m³, in accordance with “Technical Standard For Disinfection” 2002 Edition 2.1.3), one being considered as the experimental group, and the other being considered as the control group;

(8) spray bacteria contaminating device, comprising an air compressor, a pressure gauge, a gas flow meter and an aerosol sprayer;

(9) air microorganism sampling device, liquid impact sampler; and

(10) environmental condition monitoring equipment, comprising a thermometer and a hygrometer.

2. Procedure

(1) An influenza virus H1N1 suspension was taken and filtered with sterile absorbent cotton, and diluted with nutrient broth medium to the required concentration.

(2) The two test cabinets were adjusted to a temperature of 20° C.-25° C., and a humidity of 50%-70%.

(3) Equipment to be used was put into the test cabinet at one time and the door was closed. After that, all operations and manipulations of the equipment were performed outside the test cabinet through a window with a sealed sleeve or a remote controller until the end of the test, when the door could be opened.

(4) The viruses were sprayed according to the set pressure, gas flow and spray time, while stirring with a fan. After spraying the viruses, the stirring was continued for another 5 minutes, and the resulting mixture was left standing for 5 minutes. Meanwhile the test cabinets of the experimental group and the control group were sampled by using liquid impact microorganism aerosol sampler at a flow rate of 11 L/min before disinfection (20 mL of the sampling liquid, the sampling time being 2 min), as a positive control before the control group test and before disinfection treatment of the test group (i.e. the number of contaminated viruses).

(5) 125 g of the chlorine dioxide sustained-releasing sterilizing and disinfecting nano material prepared in Example 1 was tiled in the test cabinet of the experimental group to disinfect.

(6) At 2 hours, the test cabinets of the experimental group and the control group were sampled simultaneously according to the method as described in step (4).

(7) In the laboratory experimental stage, the samples collected with the liquid impact sampler were cultured by viable count method in accordance with “Technical Standard For Disinfection” (2002 Edition 2.1.1.3), in which they were cultured in a incubator at 37° C. for 48 hours, and the number of viruses in air of the test cabinet at the respective sampling time was calculated.

(8) After the whole test was completed, after the final disinfection against the residual viruses on the surface of the test cabinet and in air, the ventilator was turn on, to filter the disinfection exhaust air, and remove the contaminated air trapped in the cabinet (or room) for the next test.

(9) After sampling and sample-inoculating of the test group and the positive control group, the same batch of unused culture medium, sampling liquid, and PBS, etc. were sampled (each 1-2 groups) and cultured or cultured after inoculation at the same time as the above two sets of samples, as a negative control. If there are viruses growth in the negative control group, it means that the medium or reagents used are contaminated and that the experiment is invalid. Therefore, the test should start again after replacing sterile materials and equipment.

(10) The valid experiment under the same conditions was repeated 3 times, and the killing rate was calculated separately for each time. The killing rate was calculated according to the following formula:

$${N}_{t} = \frac{{V}_{0} - {V}_{t}}{{V}_{0}} \times 100 \%$$

$${K}_{t} = \frac{{V}_{0}^{′} ( 1 - {N}_{t} ) - {V}_{t}^{′}}{{V}_{0}^{′} ( 1 - {N}_{t} )} \times 100 \%$$

where Nₜ represents the natural killing rate of virus in air;
V₀ and Vₜ respectively represents the number of viruses in air before the experiment and at different time point during the experiment of the control group;
Kₜ represents killing rate of virus(es) in air by disinfection treatment;
V₀′ and Vₜ′ respectively represents the number of viruses in air before disinfection and at different time point during the disinfection of the experimental group,
wherein the number of viruses in air before and after disinfection were calculated according to the following formula:

$$the number of viruses in air ( TCI {D}_{50} / {m}^{3} ) = \frac{{P}_{v} ( T C I {D}_{50} / {m}^{3} )}{11 L / min \times sampling time ( min )} \times 1000$$

where Pᵥ represents the total number of viruses in the sampling plate.

The specific results were shown in Table 4.

TABLE 4
Experimental results of killing influenza virus H1N1

| | Total number of | Total number of | |
|---|---|---|---|
| | viruses in | viruses in | |
| Experimental | air at 0 h | air at 2 h | Killing rate |
| times | (TCID₅₀/m³) | (TCID₅₀/m³)) | Kₜ (%) |
| 1 | 3.52 × 10⁶ | 8.43 × 10³ | 99.73 |
| 2 | 3.52 × 10⁶ | 1.04 × 10⁴ | 99.59 |
| 3 | 3.52 × 10⁶ | 5.70 × 10³ | 99.79 |

From the above examples and use examples, it can be seen that the chlorine dioxide sustained-releasing sterilizing and disinfecting nano material prepared by the method according to the present disclosure could release chlorine dioxide with a concentration higher than 0.01 ppm for as long as 3-6 months, and have an effect of long-team sustained-release chlorine dioxide. The concentration of chlorine dioxide is relatively low, and thus it could be used in the environment that needs long-time sterilization and disinfection where human exists, and it could kill 99.6% of influenza A virus H1N1 within 2 hours, and kill 99.9% of staphylococcus albicans within 2 hours, and kill 99.4% of natural bacteria in air within 24 hours, having excellent sterilization and disinfection performance.

The above are only the preferred embodiments of the present disclosure. It should be pointed out that for those of ordinary skill in the art, without departing from the principle of the present disclosure, several improvements and modifications could be made, and these improvements and modifications shall also fall within the scope of the present disclosure.

1. A method for preparing a chlorine dioxide sustained-releasing sterilizing and disinfecting nano material, comprising
soaking a support in a chlorine dioxide-containing solution, and
filtering the resulting mixture, to obtain a solid, and drying the solid, to obtain the chlorine dioxide sustained-releasing sterilizing and disinfecting nano material,
wherein the support is a porous material with nano-silicon dioxide as a main component.

2. The method for preparing the chlorine dioxide sustained-releasing sterilizing and disinfecting nano material as claimed in claim 1, wherein the support is prepared by a method comprising
mixing a nano-silicon dioxide sol with a particle size of 1-100 nm, absolute ethanol, and deionized water, with a volume ratio of (0.75-1.5):(1-3):(6-8), to obtain a mixed solution; and
adjusting a pH value of the mixed solution to 7.4-7.6, and drying, to obtain the support.

3. The method for preparing the chlorine dioxide sustained-releasing sterilizing and disinfecting nano material as claimed in claim 1, wherein the support has a particle size of 2 to 4 mm.

4. The method for preparing the chlorine dioxide sustained-releasing sterilizing and disinfecting nano material as claimed in claim 1, wherein the chlorine dioxide-containing solution has a chlorine dioxide concentration of 5-20 wt %.

5. The method for preparing the chlorine dioxide sustained-releasing sterilizing and disinfecting nano material as claimed in claim 4, wherein a mass ratio of the chlorine dioxide-containing solution to the support is in the range of (21-26):10.

6. The method for preparing the chlorine dioxide sustained-releasing sterilizing and disinfecting nano material as claimed in claim 1, wherein soaking a support in a chlorine dioxide-containing solution is performed at a temperature of 24-26° C. for 18-26 hours.

7. The method for preparing the chlorine dioxide sustained-releasing sterilizing and disinfecting nano material as claimed in claim 1, wherein drying the solid is performed by a natural air drying.

8. A chlorine dioxide sustained-releasing sterilizing and disinfecting nano material prepared by the method as claimed in claim 1.

9. A method for sterilizing and disinfecting, comprising:
using the chlorine dioxide sustained-releasing sterilizing and disinfecting nano material as claimed in claim 8 as a sterilizing and disinfecting reagent.

10. The method for preparing the chlorine dioxide sustained-releasing sterilizing and disinfecting nano material as claimed in claim 2, wherein the support has a particle size of 2 to 4 mm.
